(19) United States
(12) Patent Application Publication
(10) Pub. No.: US 2008/0320091 A1
(43) Pub. Date: Dec. 25, 2008

(54) Communication Terminal Apparatus

(75) Inventor: Kenichi MACHIYAMA, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Oki Data Corporation, Tokyo (JP)

(21) Appl. No.: 12/142,838

(22) Filed: Jun. 20, 2008

(30) Foreign Application Priority Data
Jun. 21, 2007 (JP) 2007-164001

(51) Int. Cl. G06F 15/16

(52) U.S. Cl. 709/206

(57) ABSTRACT

A communication terminal apparatus is provided that prevents registration of a wrong mail address and prevents transmission of useless mails. The communication terminal apparatus has a recipient information memory unit for memorizing recipient information specifying a recipient of a mail, a recipient information input unit for inputting the recipient information, a recipient information verification request transmission unit for transmitting a request for verifying an existence of the recipient information inputted with the recipient information input unit, a reply reception unit for receiving a reply in response to the request transmitted by the recipient information verification request transmission unit, and a recipient information registration unit for registering, based on the reply received by the reply reception unit, the recipient information to the recipient information memory unit.

### BACKGROUND OF THE INVENTION

1. Field of the Invention

The present invention relates to a communication terminal apparatus having a function to transmit an e-mail (hereinafter simply referred to as a mail).

2. Description of Related Art

There exists a communication terminal apparatuses, capable of transmitting mails, that previously registers mail addresses and thereafter reads the registered mail address to transmit a mail to the read mail address as a recipient address. (for example, Japanese Patent Application Publication No. 2003-069799)

The communication terminal apparatus described above, however, has a problem that where a wrong mail address is registered by mistake, the apparatus transmits useless mails. Especially, where the mail address is non-existent, the apparatus repeatedly attempts to transmit the mail to the non-existent mail address.

### SUMMARY OF THE INVENTION

This invention is made to solve such problems as described above, and it is the object of the present invention to provide a communication terminal apparatus capable of preventing registration of the wrong mail address and preventing transmission of useless mails.

To solve such problems as described above, in a first aspect of the present invention corresponding to claim 1, a communication terminal apparatus has a recipient information memory unit for memorizing recipient information specifying a recipient of a mail, a recipient information input unit for inputting the recipient information, a recipient information verification request transmission unit for transmitting a request for verifying an existence of the recipient information inputted with the recipient information input unit, a reply reception unit for receiving a reply in response to the request transmitted by the recipient information verification request transmission unit, and a recipient information registration unit for registering, based on the reply received by the reply reception unit, the recipient information to the recipient information memory unit.

With the structure of the communication terminal apparatus as described above, the recipient information registration unit registers the recipient information to the recipient information memory unit where the reply received by the reply reception unit shows that the recipient information exists, and accordingly, the communication terminal apparatus prevents registration of wrong recipient information, thus preventing transmission of useless mails addressed to a wrong recipient.

A second aspect of the present invention corresponding to claim 5, a communication terminal apparatus has a recipient information memory unit for memorizing recipient information specifying a first recipient of a first mail, a recipient information input unit for inputting the recipient information, a recipient information registration unit for registering the recipient information inputted with the recipient information input unit to the recipient information memory unit, and a confirmation request transmission unit for transmitting to the first recipient specified in the recipient information memorized in the recipient information memory unit a confirmation request for confirming whether the recipient information registered to the recipient information memory unit should be deleted.

With the structure of the communication terminal apparatus as described above, the recipient information deletion unit deletes the recipient information from the recipient information memory unit where the reply in response to the confirmation request transmitted by the confirmation request transmission unit requests to delete the recipient information, and accordingly, the communication terminal apparatus can prevent the recipient information from being registered without the consent of the recipient specified in the recipient information. Further, the communication terminal apparatus registers the recipient information upon receiving the reply mail and otherwise deletes the recipient information, and thus, the recipient information remaining in the recipient information memory unit does not have a wrong mail address, so that the communication terminal apparatus does not transmit useless mails addressed to a recipient that does not exist.

Accordingly, the present invention can eliminate registration of wrong mail addresses and prevent transmission of useless mails.

A best mode for carrying out the present invention is hereinafter described.

### DETAILED DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein:

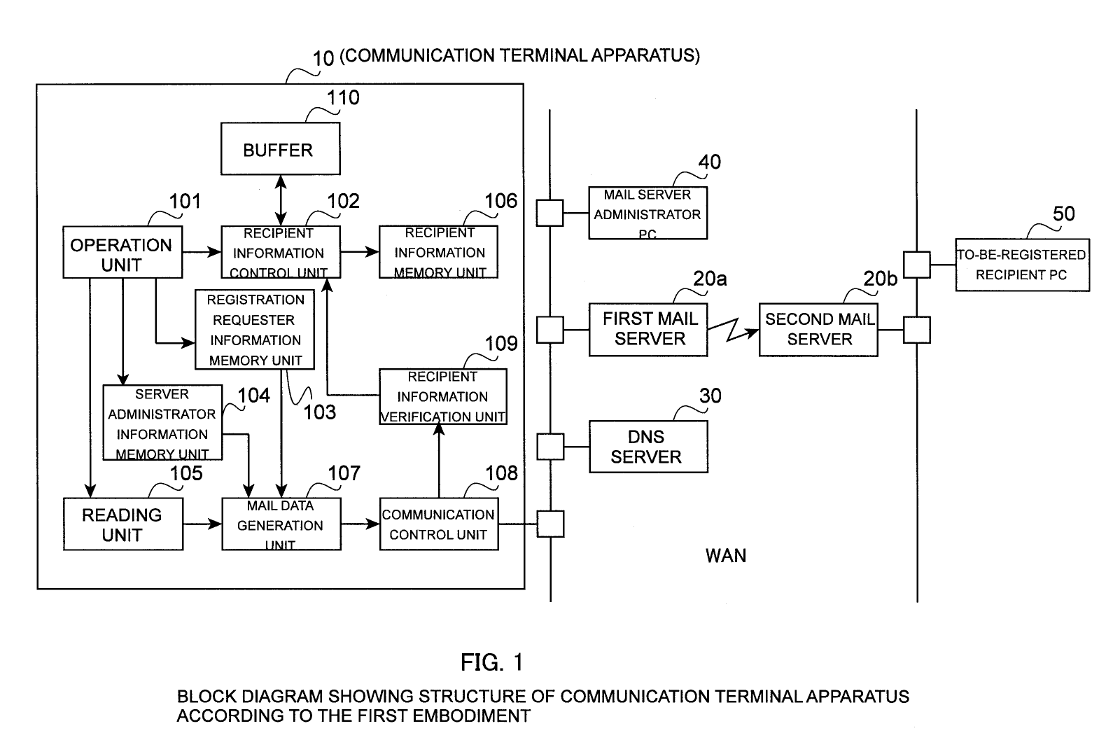

FIG. 1 is a block diagram showing a structure of a communication terminal apparatus according to the first embodiment of the present invention;

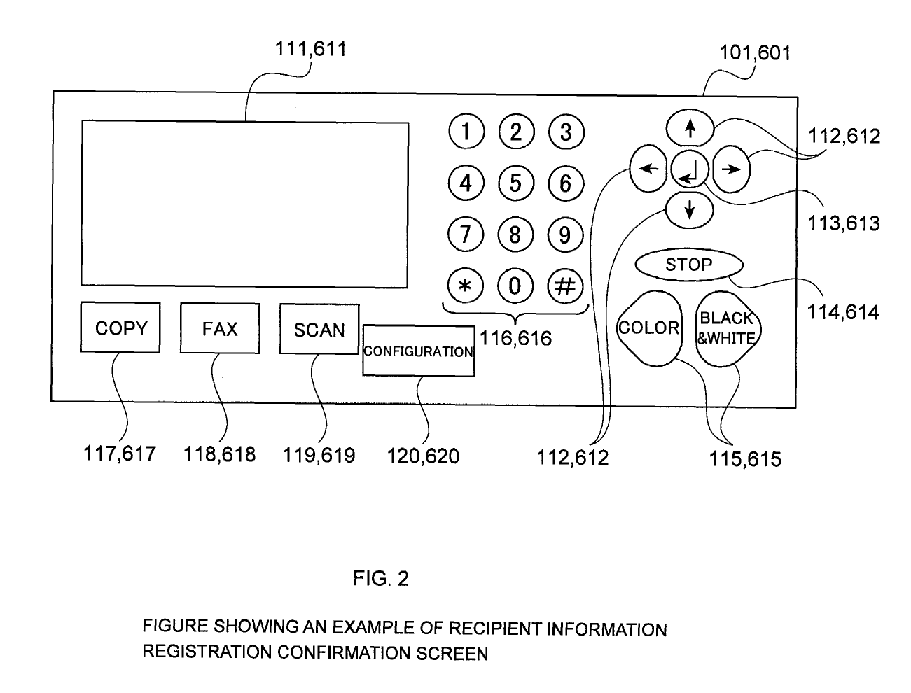

FIG. 2 is a diagram showing an example of an operation panel shown in FIG. 1;

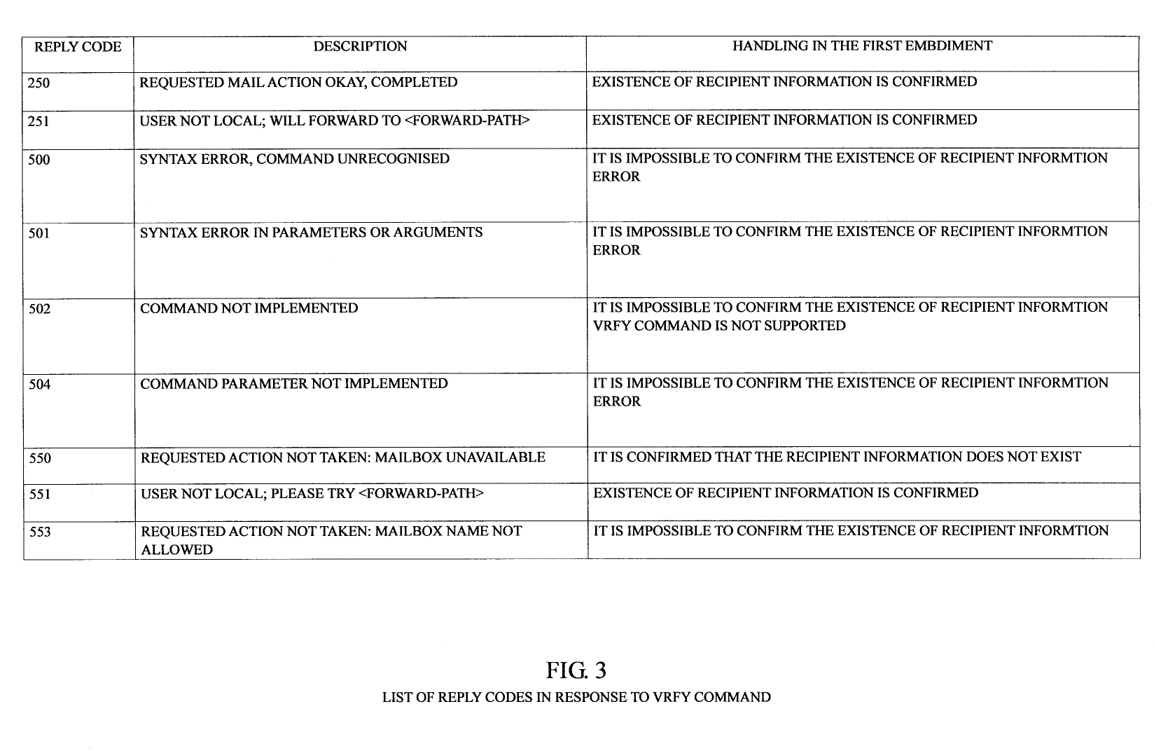

FIG. 3 is a diagram showing a list of reply codes in response to the VRFY command;

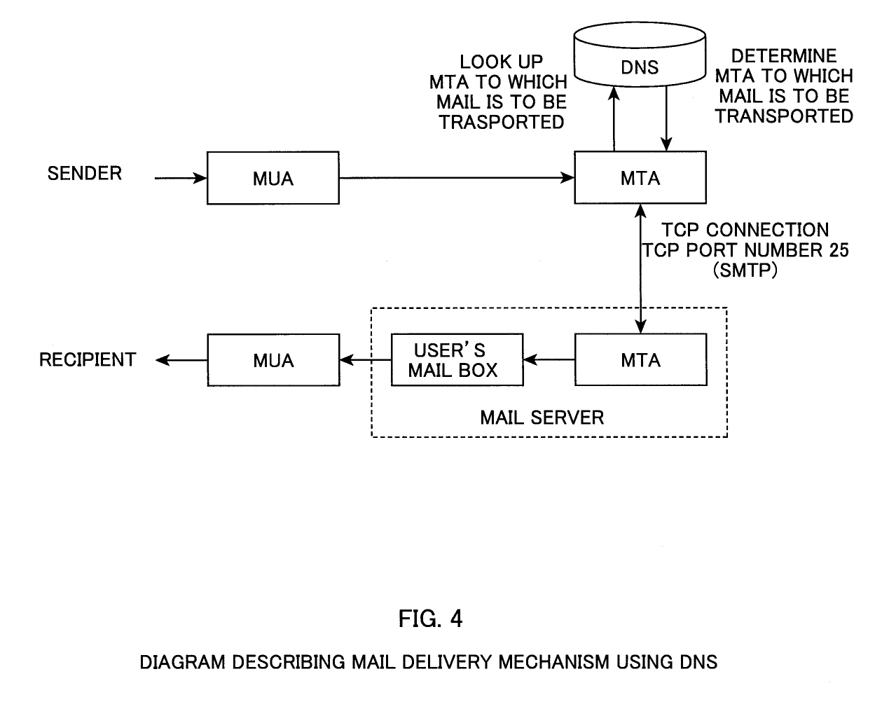

FIG. 4 is a diagram describing a mail delivery mechanism using DNS;

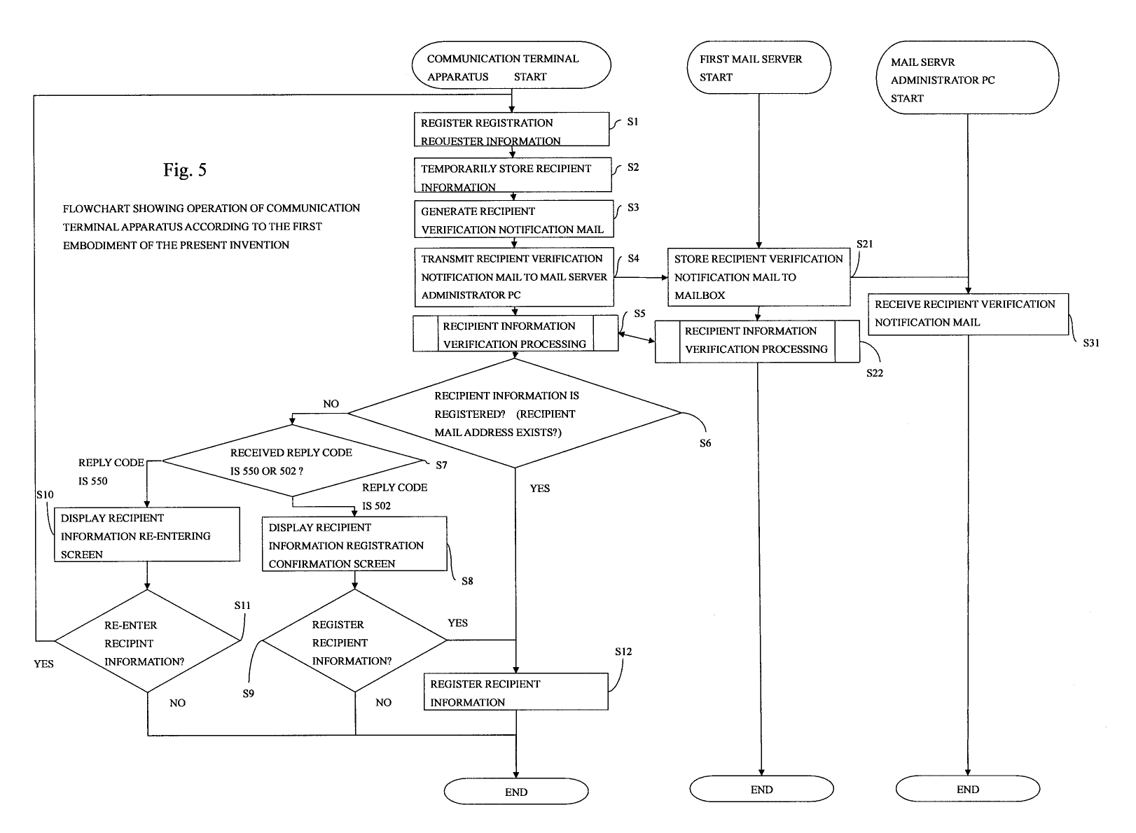

FIG. 5 is a flowchart showing operation of the communication terminal apparatus according to the first embodiment of the present invention;

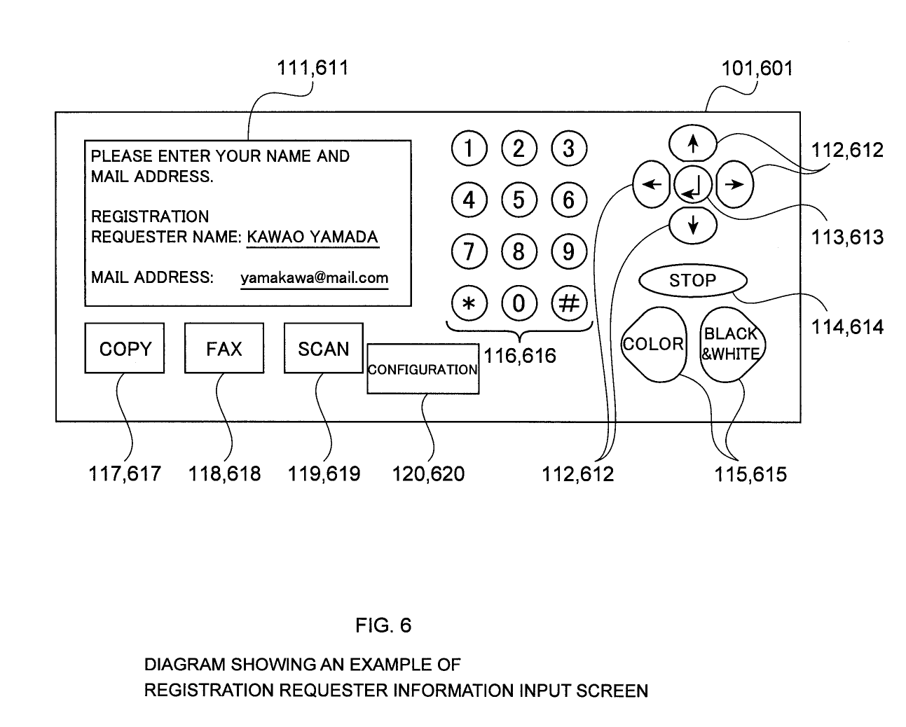

FIG. 6 is a diagram showing an example of a registration requester information input screen;

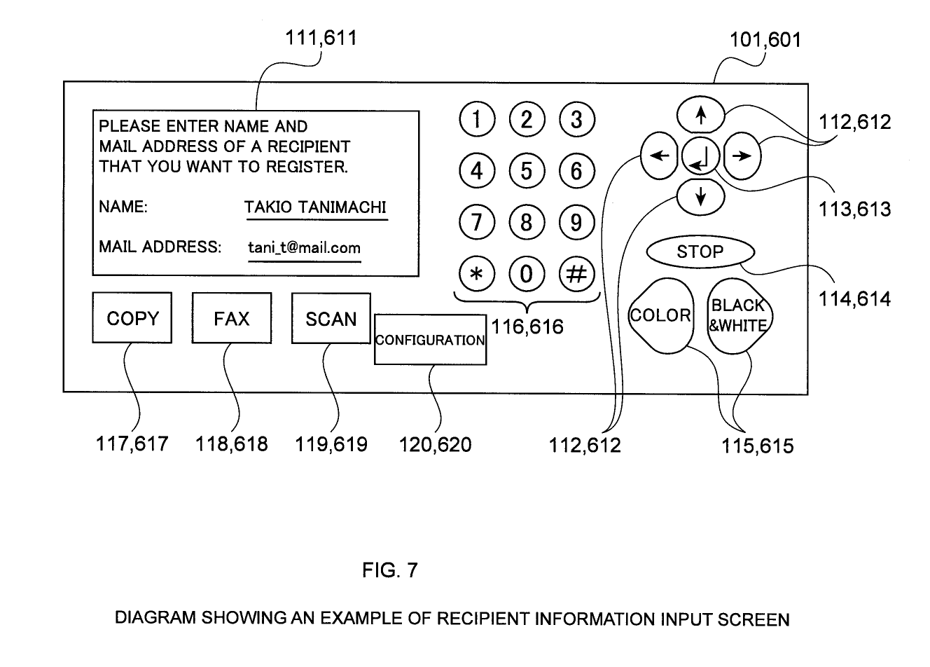

FIG. 7 is a diagram showing an example of a recipient information input screen;

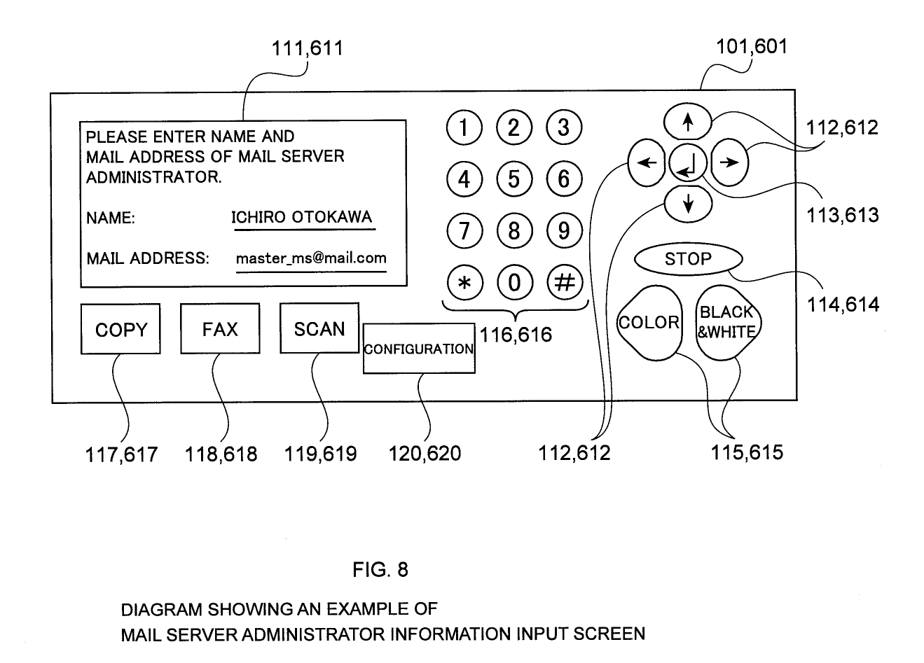

FIG. 8 is a diagram showing an example of a mail server administrator information input screen;

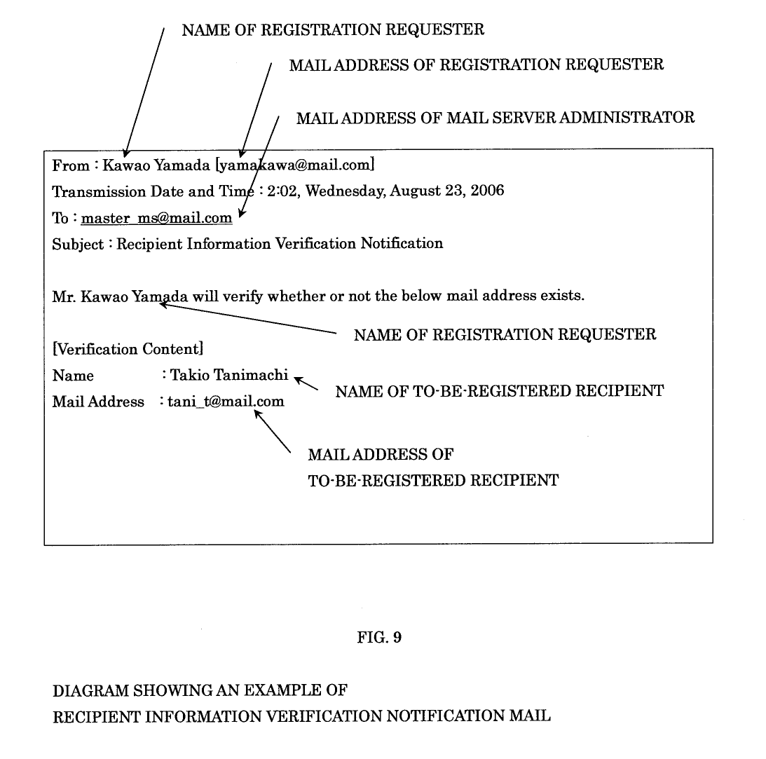

FIG. 9 is a diagram showing an example of a recipient information verification notification mail;

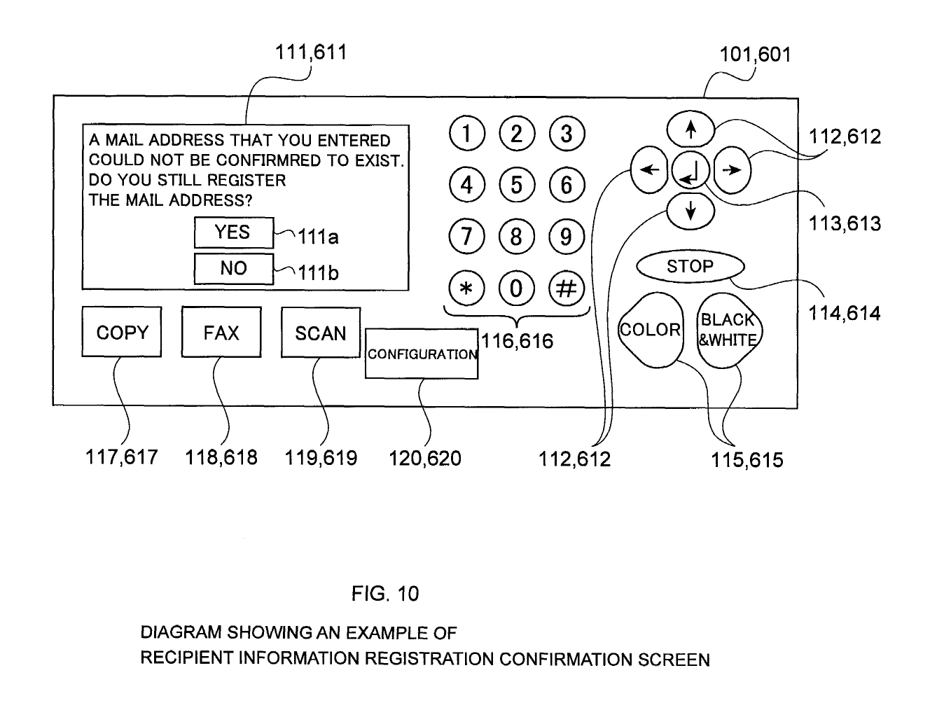

FIG. 10 is a diagram showing an example of a recipient information registration confirmation screen;

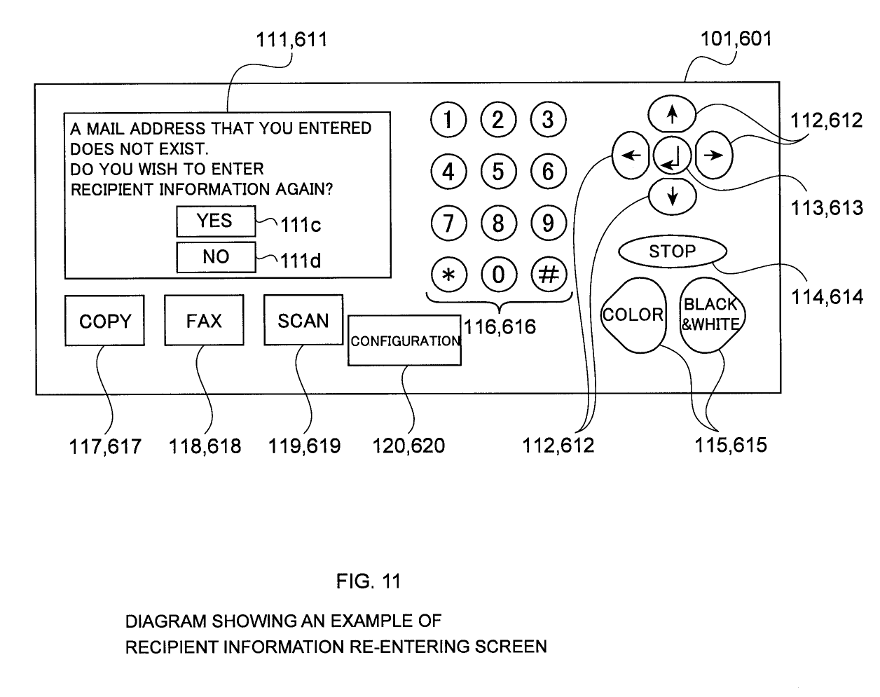

FIG. 11 is a diagram showing an example of a recipient information re-entering screen;

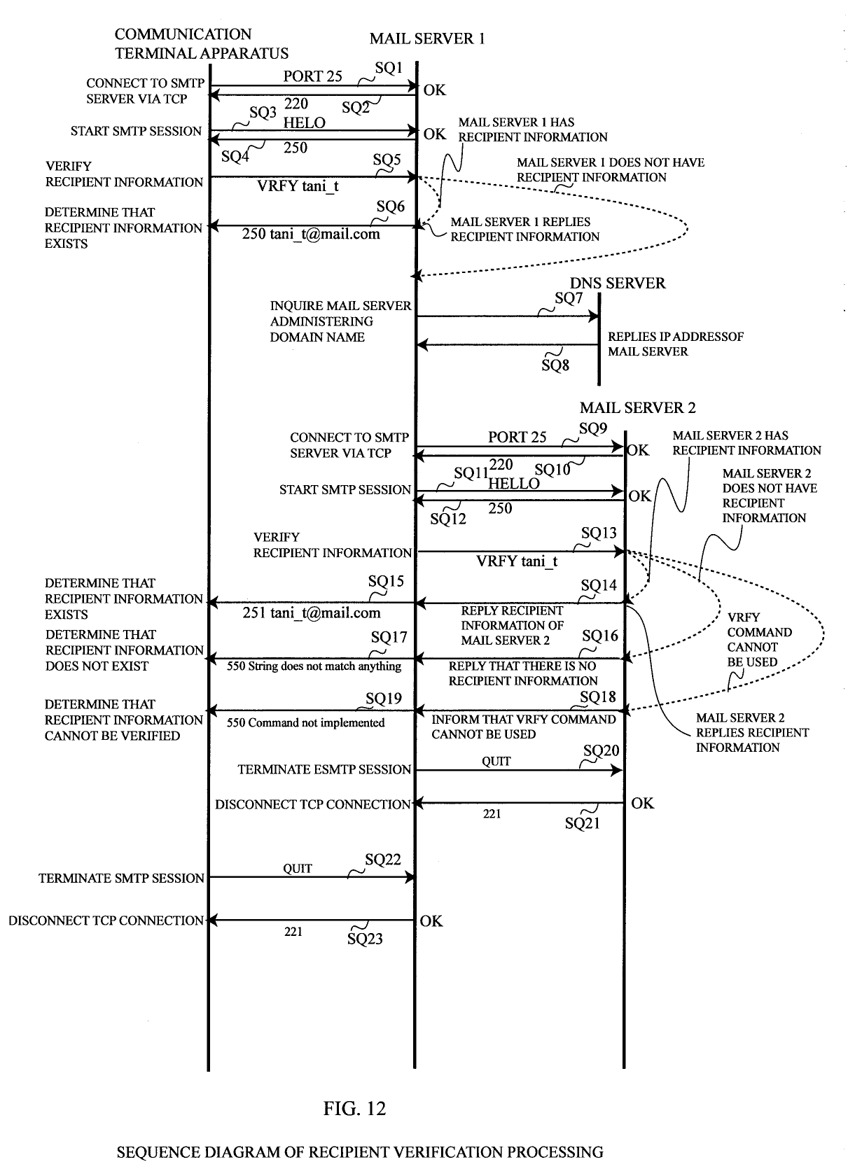

FIG. 12 is a sequence diagram of a recipient information verification processing;

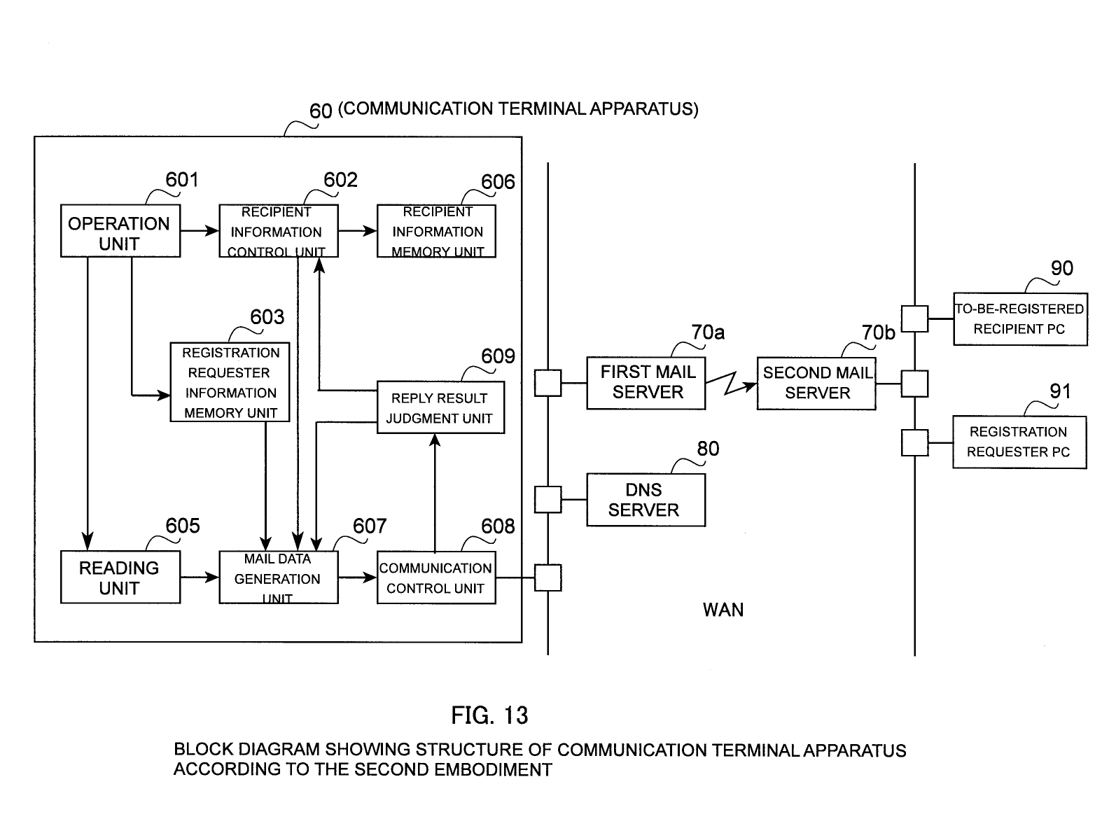

FIG. 13 is a block diagram showing structure of the communication terminal apparatus according to the second embodiment of the present invention;

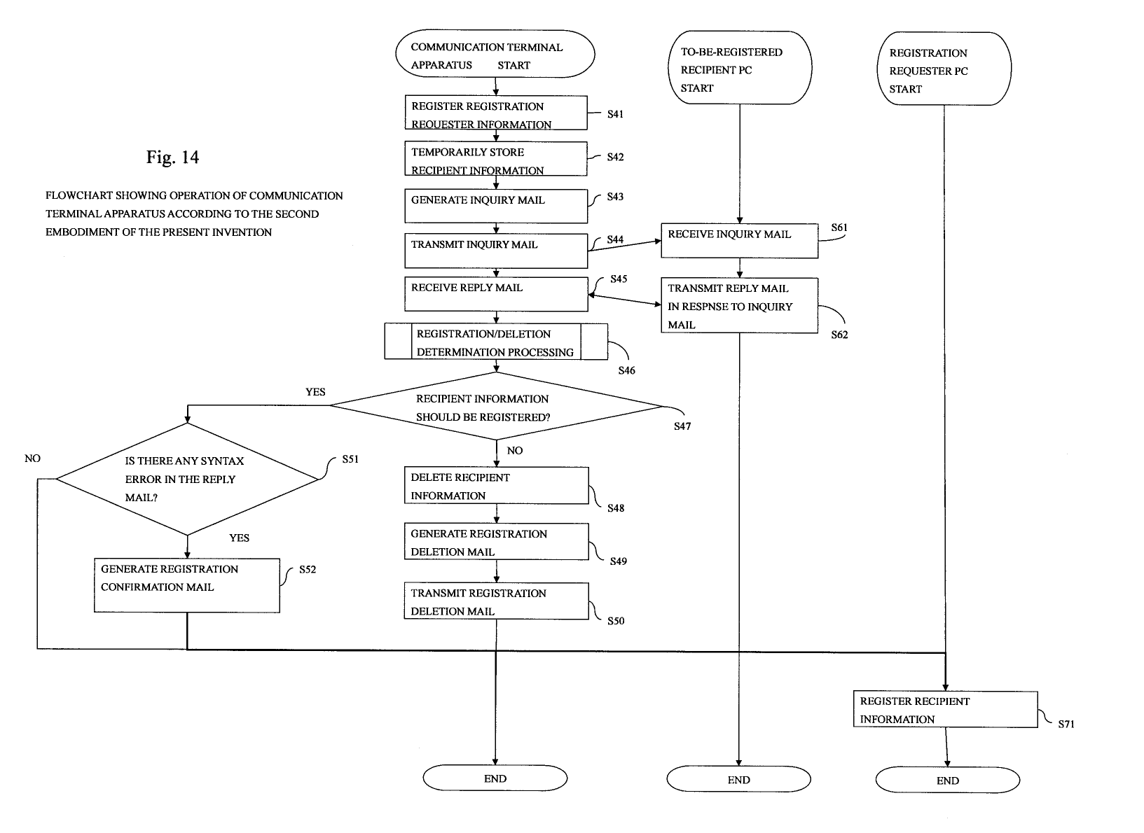

FIG. 14 is a flowchart showing operation of the communication terminal apparatus according to the second embodiment;

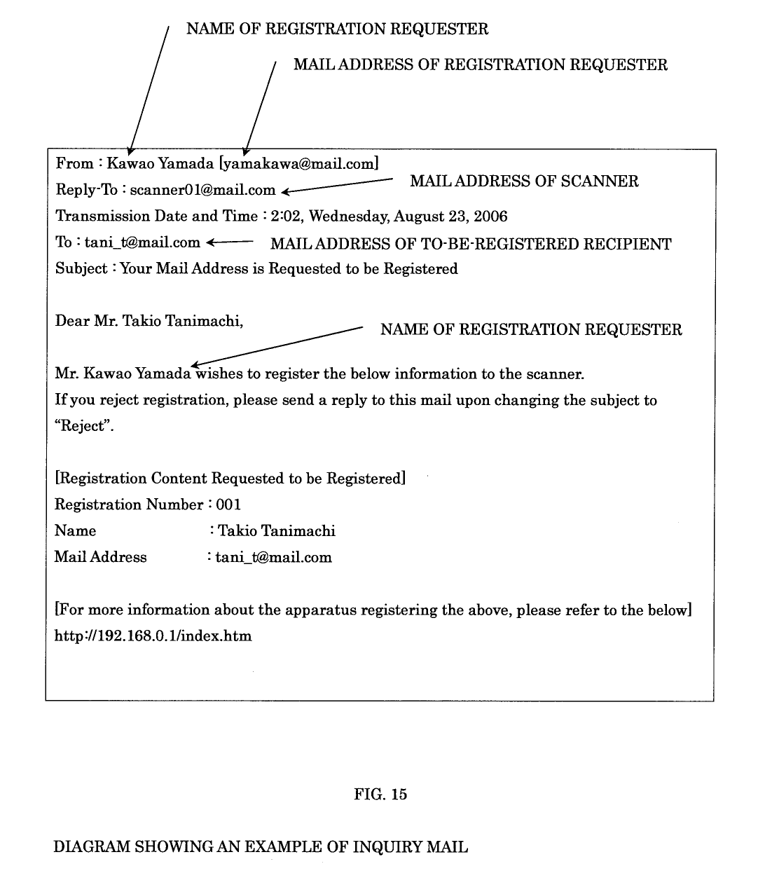

FIG. 15 is a diagram showing an example of an inquiry mail;

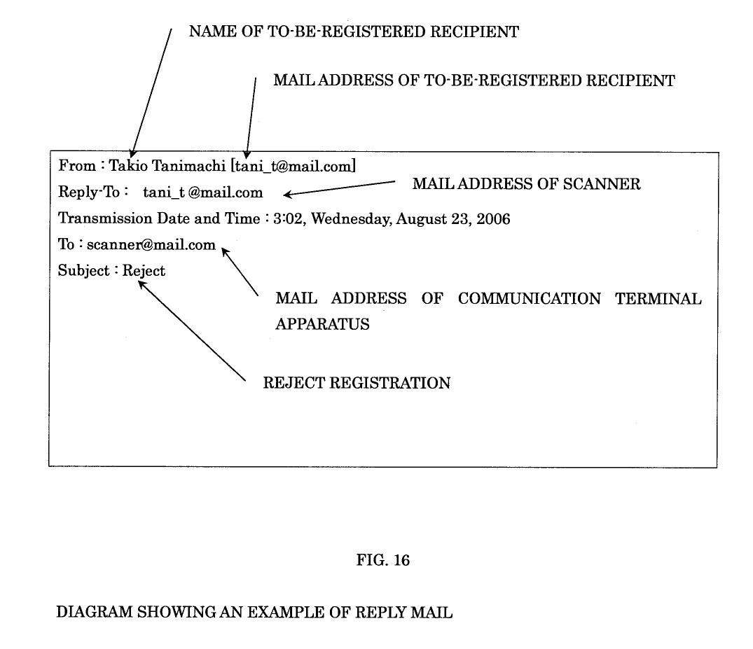

FIG. 16 is a diagram showing an example of a reply mail;

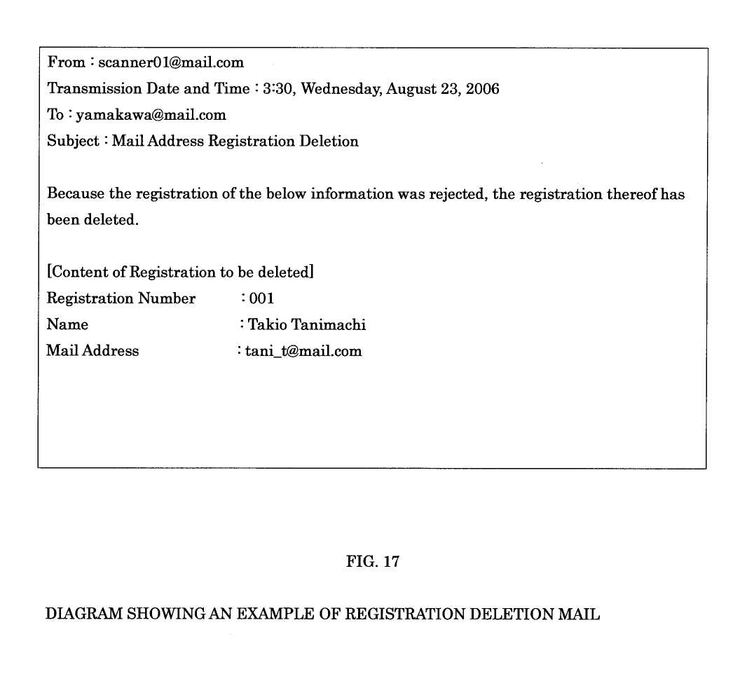

FIG. 17 is a diagram showing an example of a registration deletion mail;

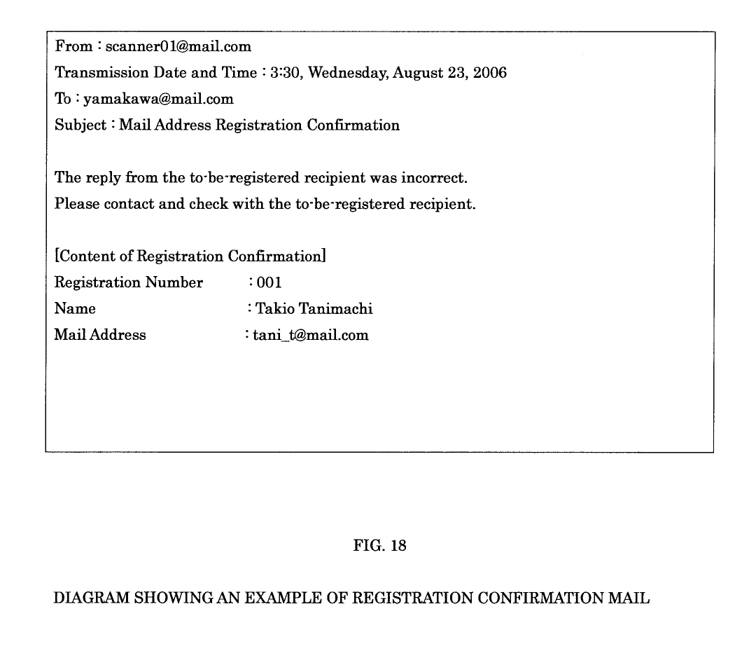

FIG. 18 is a diagram showing an example of a registration confirmation mail; and

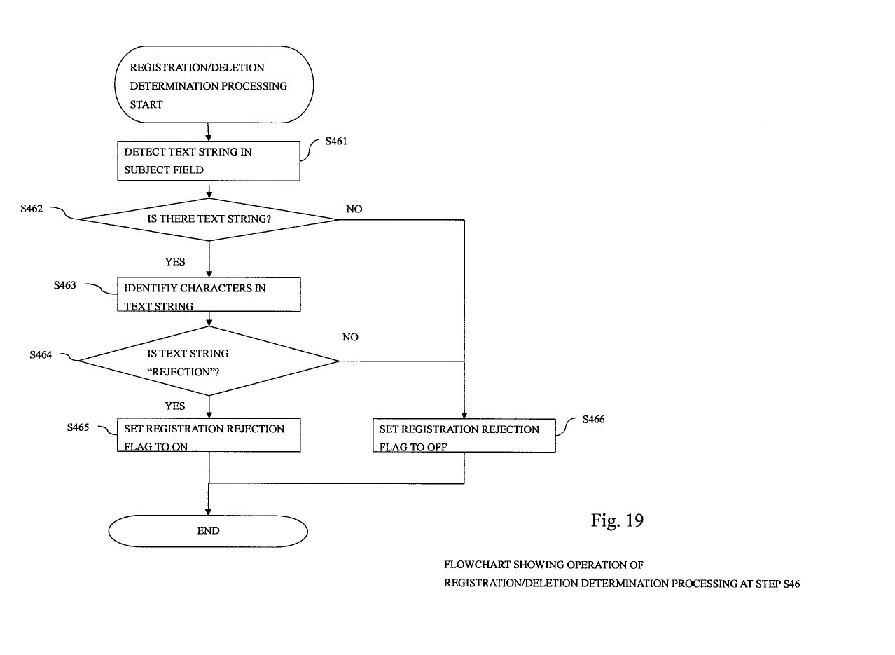

FIG. 19 is a flowchart showing operation of a registration/deletion determination processing at step S46.

### PREFERRED EMBODIMENTS

FIG. 1 is a block diagram showing a structure of a communication terminal apparatus 10 according to the first embodiment of the present invention. As shown in FIG. 1, the communication terminal apparatus 10 is capable of transmitting and receiving facsimile data to and from a facsimile apparatus and capable of transmitting image data of a read document via mail, and a WAN (Wide Area Network) connects the communication terminal apparatus 10 to a first mail server 20a for transmitting mails, a second mail server 20b, a DNS (Domain Name System) server 30 relating IP addresses to domain names, a mail server administrator PC (Personal Computer) 40 owned by a mail server administrator for administering the first mail server 20a, and a to-be-registered recipient PC (Personal Computer) 50 whose mail address (recipient information) is requested to be registered. The communication terminal apparatus 10 has an operation unit 101, a recipient information control unit 102, a registration requester information memory unit 103, a server administrator information memory unit 104, a reading unit 105, a recipient information memory unit 106, a mail data generation unit 107, a communication control unit 108, a recipient information verification unit 109, a buffer 110, a facsimile unit, not shown, and a printing unit, not shown. Herein, the recipient information control unit 102, the reading unit 105, the mail data generation unit 107, the communication control unit 108, and the recipient information verification unit 109 are generated upon execution of a control program memorized in a ROM, not shown, by a CPU, not shown, and executes functions as described later.

As shown in FIG. 2, the operation unit 101 has a display unit 111 made of a liquid crystal display apparatus displaying configuration items, apparatus status information, and the like, an arrow key 112 moving a cursor during configuration operation, an enter key 113, a stop key 114 for discontinuing operation during execution, and a start button 115 for starting copying, facsimile transmission, and scanning upon setting the mode to color or black and white.

Further, the operation unit 101 has a ten key 116 for inputting characters and numbers, a copy button 117 specifying copying operation, a facsimile button 118 specifying facsimile transmission, a scan button 119 for reading a document image, and a configuration button 120 for displaying a prescribed configuration screen on the display unit 111.

The display unit 111 is made of an LCD touch panel displaying buttons for various operations, and capable of recognizing that buttons on the touch panel are pressed down by a user, thus also functioning as an input unit.

The recipient information control unit 102 shown in FIG. 1 performs a processing for registering recipient information, made up with a name and a mail address inputted with the operation panel 101, to the recipient information memory unit 106. The registration requester information memory unit 103 is made of a RAM, and memorizes registration requester information about a registration requester who registers the recipient information. The registration requester information is information made up with a name of the registration requester and a mail address of the registration requester.

The server administrator information memory unit 104 is made of a RAM, and memorizes information (hereinafter referred to as server administrator information) about the mail server administrator administering the first mail server 20a. The server administrator information is information made up with a name of the serve administrator and a mail address of the mail server administrator PC 40. The reading unit 105 reads a document placed on a document mounting table, not shown, and outputs the read image data to the mail data generation unit 107.

The recipient information memory unit 106 is made of a RAM, and memorizes recipient information instructed by the recipient information control unit 102. The mail data generation unit 107 generates a mail having an attached image data file inputted from the reading unit 105, and also generates a later-described recipient information verification notification mail notifying the mail server administrator PC 40 that a recipient information verification is going to be performed.

The communication control unit 108 controls network communication with the first mail server 20a by transmitting STMP commands, e.g., a VRFY command, to the first mail server 20a and receiving STMP replies therefrom such as those shown in FIG. 3. For example, a reply code 250 shown in FIG. 3 means that a requested mail action is OK and has been finished normally. If the mail server 20a issues the reply code 250 in reply to the VRFY command, it means that the mail server 20a has confirmed that a user name, i.e., the recipient information, supplied as the argument of the VRFY command exists as a user in the mail server 20a. A reply code 502 means that the command is not implemented. That is, if the reply code 502 is issued in reply to the VRFY command, it means that the VRFY command for confirming whether a particular user, i.e., the recipient information, exists in a mail server is not supported by the mail server. Other commands and replies are later described as necessary.

It should be noted that the SMTP replies shown in FIG. 3 are based on RFC821, RFC1123, and RFC 2821, a memorandum published by the Internet Engineering Task Force (IETF), but the commands and replies communicated between the communication control unit 108 and the first mail server 20a are not limited to the SMTP commands and replies prescribed in RFC821, RFC1123, and RFC 2821. Any protocols can be used therebetween.

The recipient information verification unit 109 makes recipient information control unit 102 perform a confirmation processing as to whether the recipient information inputted by the operation unit 101 is existent or not. The buffer 110 temporarily stores the recipient information inputted by the operation unit 101.

A facsimile unit, not shown, transmits image data read by the reading unit 105 via facsimile as well as receives facsimiles and instructs a printing unit, also not shown, to print the received facsimile data. The printing unit prints the facsimile data received by the facsimile unit onto a recording medium as well as receives image data read by the reading unit 105 and prints the image data onto the recording medium (in other words, copying operation).

Before describing operation of the communication terminal apparatus according to the first embodiment of the present invention, how a route for transporting a mail is determined from a mail address is hereinafter briefly described.

When an MTA (Mail Transfer Agent) receives a mail having a recipient address in the form of “user name”@“host name or domain name”, the MTA sees the host name recited in the mail address to make a judgment as to whether a local host of the mail server on which the MTA is running is the ultimate destination of the mail. If the MTA determines that the local host is not the ultimate destination of the mail, the MTA transfers the mail to another MTA. On the other hand, where the MTA determines that the local host is the ultimate destination of the mail, the MTA makes an MDA (Mail Delivery Agent) deliver the mail to a mailbox in the mail server according to the username specified in the mail.

Where the MTA determines that the mail is to be transferred to another mail server, the MTA determines a mail server to which the mail is to be transported and also determines a transport route of the mail, and the MTA transmits the mail to the determined mail server on the determined transport route. There are various types of networks providing routes of mail transmission, and among such networks, a TCP/IP network is widely used. For transporting mail to a destination mail server via the TCP/IP network, the SMTP protocol (Simple Mail Transfer Protocol) is used that defines a method of mail transport between the MTA and another MTA and between an MUA (Mail User Agent, or so-called e-mail client) and the MTA.

The MTA as described above determines, according to a previously defined rule, a route to the mail server to which the mail is to be delivered to, but this determination relies on to configuration (setting) of each MTA. Accordingly, a configuration may result in a case where a mail server A cannot directly communicate with a mail server B, and in such case, the configuration should be made to cause the mail server A to once transmit the mail to a mail server C and then cause the mail server C to transmit the mail to the mail server B.

However, where the mail server A as described above transports the mail to the mail server B, each of the mail servers A, B, and C involved in the mail transport should be configured in a coordinated manner to allow the mail to be once transported from the mail server A to mail server C and thereafter transported from the mail server C to the mail server B. Otherwise, the mails cannot be delivered where the mail should be relayed by an intermediate host such as the mail server C, namely, mails can be delivered only among limited hosts directly reachable with each other.

The above description assumes a case where there exists a few mail servers, such as an intranet. A DNS (Domain Name System) can be used to enable distributing mails to wide range of recipients with the SMTP. Accordingly, mail delivery mechanism using the DNS is hereinafter described. FIG. 4 is a figure describing a mail delivery mechanism using the DNS. As shown in FIG. 4, a sender of a mail uses the MUA in the communication terminal apparatus to generate an e-mail, and transmits the mail to the MTA on the sender side. The MTA on the sender side transmits a query including a host name of a recipient mail address recited in the mail to the DNS to inquire of the DNS to which MTA the mail is to be transported.

Upon receiving the query, the DNS looks up a previously memorized MX (Mail exchanger) record for the received host name and determines the MTA to which the mail is to be transported, and informs the inquirer MTA of this determined MTA. An MX record has a host name corresponding to a domain name of a mail address.

Thereafter, the MTA on the sender side establishes a TCP connection with the MTA to which the mail is to be transported, and transfers the mail on this TCP connection using the SMTP. It should be noted that the mail is not necessarily transported to a host belonging to the domain name of the original recipient mail address, but can be transported to a host in the MX record.

Upon receiving the mail, the MTA makes the MDA store the mail to a mailbox of the recipient user. Thereafter, the recipient uses the MUA to read out the received mail.

Operation of the communication terminal apparatus according to the first embodiment of the invention is hereinafter described.

FIG. 5 is a flowchart showing operation of the communication terminal apparatus according to the first embodiment of the present invention. Before registering a recipient address to the communication terminal apparatus 10, a user who wishes to send a mail, i.e., a registration requester, for example “Mr. Kawao Yamada”, operates the configuration button 120 to display a registration requester information input screen shown in FIG. 6 on a display unit 111. Thereafter, the user uses the arrow key 112 to move a cursor to a registration requester name input field in the registration requester information input screen, enters “Kawao Yamada” therein, enters “yamakawa@mail.com” to a mail address input field for inputting a mail address of the registration requester, and thereafter enters the enter key 113, so that the operation unit 101 registers registration requester information composed of “Kawao Yamada” as the registration requester and “yamakawa@mail.com” as the registration requester mail address to the registration requester information memory unit 103 (step S1).

Subsequently, the user uses the arrow key 112 to move the cursor to a name input field, for inputting a name of a recipient of a mail, in a recipient information input screen displayed on the display unit 111 as shown in FIG. 7, enters “Takio Tanimachi” as a name, enters “tani_t@mail.com” to a mail address input field for inputting a mail address of the recipient, and thereafter enters the enter key 113. The operation unit 101 outputs to the recipient information control unit 102 recipient information composed of Takio Tanimachi” as the name and “tani_j@mail.com” as the recipient mail address.

Upon receiving from the operation panel 101 the recipient information composed of “Takio Tanimachi” as the name and “tani_t@mail.com” as the recipient mail address, the recipient information control unit 102 temporarily memorizes this recipient information in the buffer 110 (step S2).

Thereafter, the mail data generation unit 107 reads out server administrator information, memorized in the server administrator information memory unit 104, composed of “Ichiro Otokawa” as a name of an administrator administering the first mail server 20a and “master_ms@mail.com” as a mail address of the mail server administrator PC (Personal Computer) 40, and reads out registration requester information composed of “Kawao Yamada” as the registration requester and “yamakawa@mail.com” as the registration requester mail address from the registration requester information memory unit 103. The server administrator information is inputted through a mail server administrator information input screen as shown in FIG. 8. The server administrator information is composed of the administrator name and the administrator mail address. The administrator name is inputted to a name input field and is the name of the administrator who administers the first mail server 20a. The administrator mail address is inputted to a mail address input field and is the mail address of the mail server administrator PC 40.

Subsequently, the mail data generation unit 107 uses the server administrator information read out of the server administrator information memory unit 104 and the registration requester information read out of the registration requester information memory unit 103 to generate a recipient information verification notification mail as shown in FIG. 9 to inform the mail server administrator PC 40 that a inquiry about the recipient information will be sent to the mail server 20a, and outputs the generated mail to the communication control unit 108 (step S3).

In the recipient information verification notification mail as shown in FIG. 9, the sender includes the name “Kawao Yamada” and the mail address “yamakawa@mail.com” as the sender's mail address, a transmission date and time reads “2:02, Aug. 23, 2006, Wednesday”, the recipient address includes the mail address “master_ms@mail.com” of the mail server administrator PC 40, the subject includes “Recipient Information Verification Notification”, and the mail body includes the content of the verification.

The communication control unit 108 transmits the recipient information verification notification mail generated by the mail data generation unit 107 to the first mail server 20a via WAN (step S4).

The first mail server 20a stores the received recipient information verification notification mail to the mailbox of the mail server administrator PC 40 (step S21).

Thereafter, the mail server administrator PC 40 retrieves the recipient information verification notification mail from the mailbox of the first mail server 20a (step S31), and memorizes the mail to a memory unit, not shown. Therefore, the server administrator “Ichiro Otokawa” can grasp who inquires the recipient information and when and whose recipient information the registration requester inquires. Further, should there be an unauthorized access occurred, the recipient information verification notification mail memorized in the memory unit can be used as an access log for examining the details of access.

Thereafter, the communication terminal apparatus 10 and the first mail server 20a perform a confirmation processing for checking whether the recipient information “tani_t@mail.com” inputted with the operation panel 101 is existent (step S5, step S22). The detail of the confirmation processing is described later.

The recipient information verification unit 109 makes a judgment as to whether the recipient information is registered in the first mail server 20a, namely, a judgment as to whether or not the first mail server 20a has the mail account “tani_t@mail.com” or is capable of relaying mails to “tani_t@mail.com”, by making a judgment as to whether the communication control unit 108 has received the reply code 250 or 251 with the text “tani_t@mail.com” from the first mail server 20a (step S6). In a case where the communication control unit 108 receives the reply code 250 or 251 with the text “tani_t@mail.com”, namely, a case where it is determined that the recipient information is registered in either the first mail server 20a or the second mail server 20b (step S6; YES), the recipient information verification unit 109 outputs to the recipient information control unit 102 a request to memorize the recipient information composed of the name “Takio Tanimachi” and the mail address “tani_t@mail.com” registered in the buffer 110 to the recipient information memory unit 106. This request includes the mail address “tani_t@mail.com” that identifies the recipient information previously entered.

According to the request, the recipient information control unit 102 reads out the recipient information composed of the name “Takio Tanimachi” and the mail address “tani_t@mail.com” from the buffer 110, registers the recipient information to the recipient information memory unit 106 (step S12), and terminates this processing regarding the recipient information.

In a case where the communication control unit 108 has not received the reply code 250 or 251 with the text “tani_t@mail.com” from the first mail server 20a at step S6, the recipient information verification unit 109 judges as to whether the communication control unit 108 has received a reply code 550 with the text “String does not match anything” meaning that the recipient information is not registered in either of the first mail server 20a or the second mail server 20b or has received a reply code 502 with the text “Command not implemented” meaning that the command is not supported (step S7).

In a case where the communication control unit 108 has received the reply code 502 from the first mail server 20a (step S7; the reply code 502), the recipient information control unit 102 recognizes that the VRFY command is not supported and that it is impossible to check the existence of the recipient information in the mail server, and outputs a notification to that effect to the recipient information control unit 102.

When the notification notifying that it is impossible to check the existence of the recipient information is inputted from the recipient information verification unit 109 to the recipient information control unit 102, the recipient information control unit 102 does not register the recipient information memorized in the buffer 110 to the recipient information memory unit 106 but outputs to the operation unit 101 a request to display a recipient information registration confirmation screen as shown in FIG. 10 on the display unit 111.

The recipient information registration confirmation screen as shown in FIG. 10 has a button 111a labeled as “YES” to be pressed when the recipient information is to be registered, and also has a button 111b labeled as “NO” to be pressed when the recipient information is not needed to be registered.

According to the request from the recipient information control unit 102, the operation unit 101 displays the recipient information registration confirmation screen on the display unit 111 (step S8).

Thereafter, the recipient information control unit 102 receives a notification from the operation unit 101 as to whether the button 111a for “YES” or the button 111b for “NO” has been pressed down, and accordingly, the recipient information control unit 102 decides whether or not the recipient information is to be registered to the recipient information memory unit 106 (step S9). Where the recipient information control unit 102 receives a notification that the button 111a for “YES” has been pressed down (step S9; YES), the recipient information control unit 102 proceeds to the processing of step S12, and performs the processing as described above. On the other hand, where the recipient information control unit 102 receives a notification that the button 111b for “NO” has been pressed down (step S9; NO), the recipient information control unit 102 erases the recipient information memorized in the buffer 110, and terminates the processing regarding the recipient information.

In a case where the recipient information verification unit 109 judges at step S7 that the communication control unit 108 has not received the reply code 502 from the first mail server 20a but has received the reply code 550 therefrom (step S7; the reply code 550), the recipient information verification unit 109 determines that the recipient information is not registered in either of the first mail server 20a or the second mail server 20b, and outputs a notification to that effect to the recipient information control unit 102.

Upon receiving from the recipient information verification unit 109 the notification that the recipient information is not registered, the recipient information control unit 102 does not register the recipient information memorized in the buffer 110 to the recipient information memory unit 106, but outputs to the operation unit 101 a request to display a recipient information re-entering screen as shown in FIG. 11 on the display unit 111.

Upon receiving the request from the recipient information control unit 102, the operation unit 101 displays the recipient information re-entering screen on the display unit 111 (step S10). Herein, the recipient information re-entering screen as shown in FIG. 11 has a button 111c labeled as “YES” to be pressed down when the recipient information is to be re-entered, and also has a button 111d labeled as “NO” to be pressed down when the recipient information is not to be re-entered.

In this way the recipient information control unit 102 receives a notification from the operation unit 101 as to whether the button 111c for “YES” or the button 111d for “NO” has been pressed down, and accordingly, the recipient information control unit 102 determines whether or not the recipient information is to be re-entered (step S11). Where the recipient information control unit 102 receives a notification that the button 111c for “YES” has been pressed down (Step 11; YES), the recipient information control unit 102 proceeds to a processing of step 1, and performs the processing as described above. On the other hand, the recipient information control unit 102 receives a notification that the button 111d for “NO” has been pressed down (Step 11; NO), the recipient information control unit 102 erases the recipient information memorized in the buffer 110, and terminates this processing regarding the recipient information.

Hereinafter described is operation of a recipient information verification processing performed by the communication terminal apparatus 10 at step S5 and a recipient information verification processing performed by the first mail server at step S22.

FIG. 12 is a sequence diagram showing a recipient information verification processing performed by the communication terminal apparatus according to the first embodiment of the present invention at step S6 and the recipient information verification processing performed by the first mail server at step S22.

The communication control unit 108 of the communication terminal apparatus 10 transmits a TCP connection request to port 25 of the first mail server 201 via WAN (SQ1 in FIG. 12)

Upon receiving the TCP connection request from the communication terminal apparatus 10, the first mail sever 20a connects to the communication terminal apparatus 10 via TCP connection where the first mail sever 20a is ready to make the TCP connection, and thereafter, the first mail sever 20a transmits a reply code 220 meaning that the TCP connection is established normally (SQ2 in FIG. 12).

Upon receiving the response code 220, the communication terminal apparatus 10 transmits to the first mail server 20a a HELLO command requesting start of a session with the first mail server 20a under the SMTP protocol (SMTP session start request; SQ3 in FIG. 12).

Upon receiving the HELLO command from the communication terminal apparatus 10, the first mail server 20a thereafter transmits, where the first mail server 20a is ready to establish the SMTP session, to the communication terminal apparatus 10 the response code 250 meaning that the SMTP session start request has been authorized (SQ4 in FIG. 12). Thus, the SMTP protocol session between the communication terminal apparatus 10 and the first mail server 20a is established.

Upon receiving the response code 250, the communication control unit 108 of the communication terminal apparatus 10 transmits to the first mail server 20a a VRFY command with the argument “tani_t” (SQ5 in FIG. 12). The above argument “tani_t” is a username of a mail address that may be registered in the first mail server 20a, and is information for allowing the first mail server 20a to check whether the recipient information inputted by the registration requester “Kawao Yamada” is registered in the first mail server 20a.

In a case where the first mail server 20a judges that the first mail server 20a includes a registration of a mail address of a username corresponding to the argument the text “tani_t” provided with the received VRFY command, the first mail server 20a transmits to the communication terminal apparatus 10 the reply code 250 along with “tani_t@mail.com” showing that the first mail server 20a includes the registration of the recipient information (RQ6 in FIG. 12).

Upon receiving the reply code 250, the communication control unit 108 of the communication terminal apparatus 10 outputs to the recipient information verification unit 109 a notification that the communication control unit 108 has received the reply code 250. Thus, the recipient information verification unit 109 judges that the recipient information exists.

In a case where the first mail server 20a judges that the first mail server 20a does not include the registration of the mail address of the username corresponding to the argument “tani_t” provided with the received VRFY command, the first mail server 20a transmits to the DNS server 30 a query for requesting to inform the first mail server 20a of a mail server in charge of the domain name part of “tani_t@mail.com” (RQ7 in FIG. 12)

The DNS server 30 refers to an MX record memorized in the DNS server 30 to identify the mail server in charge of the domain name of the mail address, and transmits to the first mail server 20a an IP address of the second mail server 20b as the mail server in charge of the domain name (RQ8 in FIG. 12).

The first mail server 20a transmits via WAN a TCP connection request to port 25 on the IP address of the second mail server 20b, which information is notified by the DNS server 30 (RQ9 in FIG. 12).

Upon receiving the TCP connection request from the first mail server 20a, the second mail server 20b makes the TCP connection with the first mail server 20a where the second mail server 20b is ready to make the TCP connection, and thereafter, the second mail server 20b outputs to the first mail server 20a the reply code 220 showing that the second mail server 20b has successfully made the TCP connection (RQ10 in FIG. 12).

Upon receiving the reply code 220, the first mail server 20a transmits to the second mail server 20b a HELLO command meaning a request (an ESMTP session start request) for starting a session with the second mail server 20b under the SMTP protocol (RQ11 in FIG. 12).

Upon receiving the HELLO command from the first mail server 20a, the second mail server 20b thereafter outputs to the first mail server 20a the reply code 250 showing that the second mail server 20b authorizes the SMTP session where the second mail server 20b is ready to start the SMTP session (RQ11 in FIG. 12). Thereafter, the ESMTP session is established between the first mail server 20a, and the second mail server 20b.

Upon receiving the reply code 250, the first mail server 20a transmits to the second mail server 20b the VRFY command with the argument “tani_t” (RQ13 in FIG. 12). The above argument “tani_t” is a username of a mail address that may be registered in the second mail server 20b, and is information for allowing the second mail server 20b to check whether the recipient information (“username”@“hostname” (domain name)) inputted by the registration requester “Kawao Yamada” is registered in the second mail server 20b.

In a case where the second mail server 20b makes a judgment the second mail server 20b includes the registration of the mail address of the username corresponding to the argument “tani_t” provided with the received VRFY command, the second mail server 20b transmits the recipient information registered in the second mail server 20b to the first mail server 20a (RQ14 in FIG. 12).

Upon receiving the recipient information registered in the second mail server 20b from the second mail server 20b, the first mail server 20a transmits to the communication terminal apparatus 10 the reply code 251 showing that the user having the mail address “tani_t@mail.com” does not locally exist in the first mail server 20a but exists in another mail server (RQ15 in FIG. 12).

Upon receiving the reply code 251, the communication control unit 108 of the communication terminal apparatus 10 outputs to the recipient information verification unit 109 a notification that the communication control unit 108 has received the reply code 251. Thus, the recipient information verification unit 109 determines that the recipient information exists.

In a case where the second mail server 20b judges that the second mail server 20b does not include the registration of the mail address of the username corresponding to the argument “tani_t” provided with the received VRFY command, the second mail server 20b transmits to the first mail server 20a a notification that the second mail server 20b does not have the recipient information (RQ16 in FIG. 12).

Upon receiving the notification that the second mail server 20b does not have the recipient information, the first mail server 20a transmits to the communication terminal apparatus 10 the reply code 550 with a text “String does not match anything” (RQ17 in FIG. 12).

Upon receiving the reply code 550, the communication control unit 108 of the communication terminal apparatus 10 outputs to the recipient information verification unit 109 a notification that the communication control unit 108 has received the reply code 550. Thus, the recipient information verification unit 109 determines that the recipient information does not exist.

In a case where the second mail server 20b does not judges that the second mail server 20b does not include the registration of the mail address of the username corresponding to the argument “tani_t” provided with the received VRFY command but judges that the received VRFY command is a unusable command, the second mail server 20b transmits to the first mail server 20a a notification that the VRFY command is unusable (RQ18 in FIG. 12)

Upon receiving the notification that the VRFY command is unusable, the first mail server 20a transmits to the communication terminal apparatus 10 the reply code 502 with a text “Command not implemented” showing that the first mail server 20a was unable to confirm the existence of the recipient information, namely, showing that the VRFY command is not supported by the second mail server 20b (RQ19 in FIG. 12).

Upon receiving the reply code 502, the communication control unit 108 of the communication terminal apparatus 10 outputs to the recipient information verification unit 109 a notification that the communication control unit 108 has received the reply code 502. Thus, the recipient information verification unit 109 determines that it is impossible to confirm the existence of the recipient information.

After the first mail server 20a transmits to the communication terminal apparatus 10 either of the reply codes 251, 550, or 502 as described above, the first mail server 20a transmits to the second mail server 20b a “QUIT” command for terminating the ESMTP session established with the second mail server 20b (RQ20 in FIG. 12).

Upon receiving the “QUIT” command, the second mail server 20b thereafter outputs to the first mail server 20b the reply code 221 showing that the second mail server 20b has confirmed to terminate the SMTP session where the second mail server 20b is ready to terminate the SMTP session (RQ21 in FIG. 12). Thereafter, the first mail server 201 terminates the TCP connection.

Thereafter, the communication control unit 108 of the communication terminal apparatus 10 transmits to the first mail server 20a a “QUIT” command for terminating the SMTP session established with the first mail server 20a (RQ22 in FIG. 12).

Upon receiving the “QUIT” command, the first mail server 20a thereafter outputs to the communication terminal apparatus 10 the reply code 221 showing that the first mail server 20a confirms to terminate the SMTP session where the first mail server 20a is ready to terminate the SMTP session (RQ23, in FIG. 12). Thereafter, the communication control unit 108 of the communication terminal apparatus 10 disconnects the TCP connection and terminates the recipient information verification processing.

With the communication terminal apparatus according to the first embodiment of the present invention as described above, where the recipient information verification unit 109 receives the reply code 250 along with the “tani_t@mail.com” or the reply code 251 from the first mail server 20a via the communication control unit 108, a recipient information registration unit registers the corresponding recipient information to the recipient information memory unit 106. Therefore, the communication terminal apparatus of the first embodiment prevents a wrong mail address from being registered, and as a consequence, prevents transmission of useless mails addressed to a recipient that does not exist.

With the communication terminal apparatus of the first embodiment, the mail data generation unit 107 generates the recipient information verification notification mail notifying that the recipient information verification processing is performed against the first mail server 20a, and the communication control unit 108 transmits the recipient information verification notification mail to the mail server administrator PC 40. Therefore, the administrator of the mail server can know who inquires the recipient information and when and whose recipient information the registration requester inquires. Further, should there be an unauthorized access occurred, the recipient information verification notification mail memorized in the memory unit can be used as an access log for examining the detail of access.

### SECOND EMBODIMENT

FIG. 13 is a block diagram showing a structure of the communication terminal apparatus according to the second embodiment of the present invention. As shown in FIG. 13, a communication terminal apparatus 60 is capable of transmitting and receiving facsimile data to and from a facsimile apparatus and capable of transmitting image data of a read document via mail, just like the communication terminal apparatus 10 according to the first embodiment. The WAN connects the communication terminal apparatus 60 to a first mail server 70a and a second mail server 70b for transmitting mails, a DNS (Domain Name System) server 80, a to-be-registered recipient PC 90 and a registration requester PC 91 for transmitting and receiving mails. The communication terminal apparatus 60 has an operation unit 601, a recipient information control unit 602, a registration requester information memory unit 603, a reading unit 605, a recipient information memory unit 606, a mail data generation unit 607, a communication control unit 608, a reply result judgment unit 609, a facsimile unit, not shown, and a printing unit, not shown. Herein, the operation unit 601, the recipient information control unit 602, the reading unit 605, the mail data generation unit 607, the communication control unit 608, and the reply result judgment unit 609, are generated upon execution of a control program memorized in a ROM, not shown, by a CPU, not shown, and executes functions as described later.

The operation unit 601, the registration requester information memory unit 603, the reading unit 605, the recipient information memory unit 606, the communication control unit 608, the facsimile unit, and the printing unit are the same as the operation unit 101, the registration requester information memory unit 103, the reading unit 105, the recipient information memory unit 106, the communication control unit 108, the facsimile unit, and the printing unit, respectively. As shown in FIG. 2, the operation unit 601 has a display unit 611, an arrow key 612, an enter key 613, a stop key 614, a start button 615, a ten key 616, a copy button 617, a facsimile button 618, a scan button 619, and a configuration button 620. Each of the above elements in the operation unit 601 is the same as a corresponding element of the first embodiment.

The recipient information control unit 602 registers to the recipient information memory unit 606 the recipient information made up with a name and a mail address inputted with the operation panel 601, and deletes the recipient information whose registration has been rejected.

The mail data generation unit 607 generates a later-described query mail as shown in FIG. 15, a later-described registration deletion mail as shown in FIG. 17, and a later-described registration confirmation mail as shown in FIG. 18, and outputs these mails to the communication control unit 608.

The reply result judgment unit 609 refers to a content of a later-described reply mail inputted by the communication control unit 608, and makes judgment as to whether the recipient information may be left registered to the recipient information memory unit 606 or should be deleted. Then, in a case where the reply result judgment unit 609 judges that the recipient information is not to be registered, the reply result judgment unit 609 outputs to the recipient information control unit 602 a request to delete the recipient information from the recipient information memory unit 606.

In a case where the reply result judgment unit 609 judges that the recipient information is to be registered, the reply result judgment unit 609 makes a judgment as to whether there exists any later-described syntax error in the reply mail. In a case where the reply result judgment unit 609 judges that there exists a syntax error in the reply mail, the reply result judgment unit 609 outputs to the mail data generation unit 607 a request to generate a later-described registration confirmation mail which is to be transmitted to the registration requester PC 91 of the registration requester.

Operation of the communication terminal apparatus according to the second embodiment of the present invention.

FIG. 14 is a flowchart showing operation of the communication terminal apparatus according to the second embodiment of the present invention. It should be noted that the communication terminal apparatus 60 is described using examples used in the first embodiment again as necessary when the communication terminal apparatus 60 is described hereinbelow.

Before registering the recipient address to the communication terminal apparatus 60, a user who wishes to send a mail, i.e., a registration requester, for example “Mr. Kawao Yamada”, operates the configuration button 620 to display the registration requester information input screen shown in FIG. 6 on a display 611. Thereafter, the user uses the arrow key 612 to move the cursor to the registration requester name input field in the registration requester information input screen, enters “Kawao Yamada” therein using the ten key 616, enters “yamakawa@mail.com” to a mail address input field for inputting a mail address of the registration requester, and thereafter enters the enter key 113, so that the operation unit 601 registers registration requester information composed of “Kawao Yamada” as the registration requester and “yamakawa@mail.com” as the registration requester mail address to the registration requester information memory unit 603 (step S41).

Subsequently, the user uses the arrow key 612 to move the cursor to the name input field, for inputting a name of the recipient of a mail, in the recipient information input screen displayed on the display unit 611 as shown in FIG. 7, enters “Takio Tanimachi” as a name, enters “tani_t@mail.com” to the mail address input field for inputting the mail address of the recipient, and thereafter enters the enter key 613. The operation unit 601 outputs to the recipient information control unit 102 recipient information composed of “Takio Tanimachi” as the name and “tani_t@mail.com” as the recipient mail address.

Upon receiving from the operation panel 601 the recipient information composed of “Takio Tanimachi” as the name and “tani_t@mail.com” as the recipient mail address, the recipient information control unit 602 temporarily memorizes this recipient information to the recipient information memory unit 606 (step S42).

Thereafter, the mail data generation unit 607 reads out from the registration requester information memory unit 603 the registration requester information composed of the name “Kawao Yamada” and the registration requester mail address “yamakawa@mail.com”.

The mail data generation unit 607 uses the recipient information inputted from the recipient information control unit 602 and the registration requester information read out from the registration requester information memory unit 603 to generate a mail (hereinafter referred to as “an inquiry mail”) addressed to “tani_t@mail.com” for inquiring the recipient as to whether the recipient wishes registration of the recipient information (step S43), and outputs the inquiry mail to the communication control unit 608.

As shown in FIG. 15, in the inquiry mail, a sender field (“from field”) includes the name and the mail address of the registration requester who requested registration of the recipient information, a reply-to field includes the mail address of the communication terminal apparatus, a recipient field (“to field”) includes the mail address of the to-be-registered recipient, and a subject field includes “Your Mail Address is Requested to be Registered”. Other description of the inquiry mail is as shown in FIG. 15.

The communication control unit 608 transmits via WAN by way of the first mail server 70a the inquiry mail generated by the mail data generation unit 607 to the mailbox, in the second mail server 70b, for the to-be-registered recipient PC 90, namely, a PC owned by the to-be-registered recipient “Takio Tanimachi” (step S44).

Thereafter, the to-be-registered recipient PC 90 retrieves the inquiry mail stored in the mailbox in the second mail server 70b (step S61).

The to-be-registered recipient “Takio Tanimachi” reads a content of the received inquiry mail, and determines as to whether he allows the registration or rejects the registration. As a result of determination, in a case where the to-be-registered recipient rejects the communication terminal apparatus 60 from registering the recipient information, the to-be-registered recipient prepares the reply mail by replacing “Subject: Your Mail Address is Requested to be Registered” with “Subject: Reject” as shown in FIG. 16. On the other hand, in a case where the to-be-registered recipient does not reject the communication terminal apparatus 60 from registering the recipient information, the to-be-registered recipient prepares the reply mail without changing the subject.

As shown in FIG. 16, in the reply mail for rejecting the registration of the recipient information, the sender field includes the name “Tatsuo Tanimachi” and the mail address “tani_t@mail.com” of the to-be-registered recipient, the reply-to field includes the mail address “tani_t@mail.com” of the to-be-registered recipient, the recipient field includes the mail address “scanner@mail.com” of the communication terminal apparatus 60, and the subject field includes “Reject”.

The to be-registered recipient PC 90 transmits via the second mail server 70b the reply mail generated by operation of the to-be registered recipient “Takio Tanimachi” to the mailbox, in the first mail server 70a, for the communication terminal apparatus 60 (step S62).

Thereafter, the communication control unit 608 of the communication terminal apparatus 60 retrieves from the mailbox in the first mail server 70a the reply mail sent from the to-be-registered recipient PC 90 (step S45), and outputs the reply mail to the reply result judgment unit 609.

The reply result judgment unit 609 of the communication terminal apparatus 60 refers to the inputted reply mail, and performs a processing (a registration/deletion determination processing) for checking as to whether the recipient information composed of the name “Takio Tanimachi” and the mail address “tani_t@mail.com” should be left registered in the recipient information memory unit 606 or should be deleted (step S46). The detail of this registration/deletion determination processing is later described in detail.

As a result of the registration/deletion determination processing, the reply result judgment unit 609 make a judgment (step S47) as to whether the recipient information about the to-be-registered recipient PC 90 should be registered based on a registration rejection flag (a flag memorized in a memory unit, not shown). In a case where the registration rejection flag is ON, namely, a case where the recipient information is not to be registered (step S47; NO), the reply result judgment unit 609 outputs to the recipient information control unit 602 a request to delete from the recipient information memory unit 606 the recipient information composed of the name “Takio Tanimachi” and the mail address “tani_t@mail.com”.

Upon receiving the request from the reply result judgment unit 609, the recipient information control unit 602 deletes the recipient information composed of the name “Takio Tanimachi” and the mail address “tani_t@mail.com” from the recipient information memory unit 606 according to the request (step S48), and then, outputs to the mail data generation unit 607 a notification that the deletion has been made.

Upon receiving from the recipient information control unit 602 the notification that the deletion has been made, the mail data generation unit 607 generates a registration deletion mail as shown in FIG. 16 to notify the registration requester “Kawao Yamada”, who requested to register this recipient information, that the recipient information composed of the name “Takio Tanimachi” and the mail address “tani_t@mail.com” has been deleted (step S49), and outputs the generated registration deletion mail to the communication control unit 608.

As shown in FIG. 17, in the registration deletion mail, the sender field includes the mail address of the communication terminal apparatus, a transmission date reads “3:30, Wednesday, Aug. 23, 2006”, the recipient field includes the mail address “yamakawa@mail.com” of “Kawao Yamada”, the subject field includes “Mail Address Registration Deletion”, and further the mail body includes a content of the registration deletion.

The communication control unit 608 transmits via WAN by way of the first mail server 70a the registration deletion mail generated by the mail data generation unit 607 to the mailbox, in the second mail server 70b, for the registration requester PC 91 of “Kawao Yamada” (step S50), and terminates the processing.

Thereafter, the registration requester PC 91 retrieves the registration deletion mail from the mailbox in the second mail server 70b, and terminates the processing. Thus, the registration requester is able to know that the previously entered registration information has been deleted.

At step S47, in a case where the registration rejection flag is OFF, namely, a case where the recipient information is to be registered (step S47; YES), the reply result judgment unit 609 makes a judgment as to whether there exists any syntax error (step S51). In a case where the reply result judgment unit 609 judges that there exists a syntax error in the reply mail (step S51; Yes), the reply result judgment unit 609 outputs to the mail data generation unit 607 a request for generating the registration confirmation mail. Herein, cases where the reply result judgment unit 609 judges that there exists a syntax error includes a case where there is a structural defect in the reply mail, for example, a case where the subject field reciting a title of the mail or the from-field reciting the sender of the mail is missing.

Upon receiving the request for generation of the registration confirmation mail, the mail data generation unit 607 generates the registration confirmation mail as shown in FIG. 18, and outputs the generated registration confirmation mail to the communication control unit.

In the registration confirmation mail as shown in FIG. 18, the sender field includes the mail address of the communication terminal apparatus, the transmission date reads “3:30, Wednesday, Aug. 23, 2006”, the recipient field includes the mail address “yamakawa@mail.com” of “Kawao Yamada”, the subject field includes “Mail Address Registration Confirmation”, and further the mail body includes a content of the registration confirmation.

The communication control unit 608 transmits via WAN by way of the first mail server 70a the registration confirmation mail generated by the mail data generation unit 607 to the mailbox, in the second mail server 70b, for the registration requester PC 91 of “Kawao Yamada”, step S52), and terminates the processing.

Thereafter, the registration requester PC 91 retrieves the registration confirmation mail from the mailbox in the second mail server 70b (step S71), and terminates the processing. The registration confirmation mail informs the registration requester that the reply mail sent from the to-be-registered recipient includes some errors.

At step S51, in a case where the reply result judgment unit 609 judges that there is no syntax error (step S51; NO), the reply result judgment unit 60 terminates the processing.

The registration/deletion confirmation processing of step S46 is hereinafter described.

FIG. 19 is a figure showing operation of the registration/deletion confirmation processing at step S46. Upon receiving the reply mail from the communication control unit 608, the reply result judgment unit 609 searches a text string in the subject field of the reply mail (step S461), and makes a judgment as to whether there is the text string (step S462).

In a case where the reply result judgment unit 609 judges that there is no text string in the subject field (step S462; NO), the reply result judgment unit 609 sets the registration rejection flag memorized in the memory unit, not shown, to OFF (step S466), and terminates the registration/deletion confirmation processing. On the other hand, in a case where the reply result judgment unit 609 judges that there is the text string in the subject field (step S462; YES), the reply result judgment unit 609 identifies characters of the text string (step S463).

As a result of identifying the characters of the text string, the reply result judgment unit 609 makes a judgment as to whether the text string is “Rejection” (step S464). Where the reply result judgment unit 609 judges that the text string is not “Rejection” (step S464; NO), the reply result judgment unit 609 proceeds to step S466. On the other hand, where the reply result judgment unit 609 judges that the text string is “Rejection” (step S464; YES), the reply result judgment unit 609 sets the registration rejection flag to ON, and terminates the registration/deletion confirmation processing.

With the communication terminal apparatus according to the second embodiment, in a case where the reply result judgment unit 609 judges that the reply mail sent from the to-be-registered recipient PC 90 in response to the inquiry mail sent form the communication control unit 608 is requesting to reject the registration of the recipient information, the recipient information control unit 602 deletes the recipient information from the recipient information memory unit 606, and thus, the communication terminal apparatus prevents the recipient information from being registered without the consent of the to-be-registered recipient. Further, the communication terminal apparatus registers the recipient information upon receiving the reply mail and otherwise deletes the recipient information, and thus, the recipient information remaining in the recipient information memory unit does not have a wrong mail address, so that the communication terminal apparatus does not transmit useless mails addressed to a recipient that does not exist.

With the communication terminal apparatus according to the second embodiment, in a case where the recipient information control unit 602 deletes the recipient information from the recipient information memory unit 606, the mail data generation unit 607 generates the registration deletion mail for notifying the registration requester that the recipient information has been deleted, and the communication control unit 608 transmits the generated mail to the registration requester PC, so that the registration requester can know that the previously entered recipient information has been deleted.

With the communication terminal apparatus according to the second embodiment, in a case where the reply mail from the to-be-registered PC 90 in response to the inquiry mail sent from the communication controller 608 is not requesting to reject the registration of the recipient information but includes a mere syntax error, the communication terminal apparatus transmits to the registration requester PC 91 the registration confirmation mail for requesting to confirm the recitation in the reply mail, and accordingly, the registration requester may contact the to-be-registered recipient who sent the reply mail and discuss about the recitation in the reply mail.

In the embodiments of the present invention, the communication terminal apparatus uses the VRFY command of SMTP protocol to check whether a certain mail account (mail address) exists in the mail server. However, the existence of a mail account in the mail server can be checked by simply sending a mail to that mail account without using the VRFY command. If the mail server does not allow VRFY command, it may be useful to simply send a mail to that mail account and see if any error mail is returned back from that mail server, so that the communication terminal apparatus can identify whether the mail account (mail address) exists in the mail server without relying on the VRFY command.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. A communication terminal apparatus comprising:
a recipient information memory unit for memorizing recipient information specifying a recipient of a mail;
a recipient information input unit for inputting the recipient information;
a recipient information verification request transmission unit for transmitting a request for verifying an existence of the recipient information inputted with the recipient information input unit;
a reply reception unit for receiving a reply in response to the request transmitted by the recipient information verification request transmission unit; and
a recipient information registration unit for registering, based on the reply received by the reply reception unit, the recipient information to the recipient information memory unit.

2. The communication terminal apparatus according to claim 1 further comprising:
a response judgment unit for making a judgment as to whether or not the reply received by the reply reception unit shows that the recipient information exists,
wherein where the response judgment unit judges that the reply received by the reply reception unit shows that the recipient information exists, the recipient information registration unit registers the recipient information to the recipient information memory unit.

3. The communication terminal apparatus according to claim 1 further comprising:
a verification notification mail generation unit for generating a verification notification mail notifying that the request for verifying the existence of the recipient information is transmitted; and
a verification notification mail transmission unit for transmitting the verification notification mail generated by the verification notification mail generation unit where the recipient information verification request transmission unit transmits the request for verifying the existence of the recipient information.

4. The communication terminal apparatus according to claim 1,
wherein the request transmitted by the recipient information verification request transmission unit includes a VRFY command according to SMTP (Simple Mail Transfer Protocol).

5. A communication terminal apparatus comprising:
a recipient information memory unit for memorizing recipient information specifying a first recipient of a first mail;
a recipient information input unit for inputting the recipient information;
a recipient information registration unit for registering to the recipient information memory unit the recipient information inputted with the recipient information input unit; and
a confirmation request transmission unit for transmitting to the first recipient specified in the recipient information memorized in the recipient information memory unit a confirmation request for confirming whether the recipient information in the recipient information memory unit should be deleted.

6. The communication terminal apparatus according to claim 5 further comprising:
a recipient information deletion unit for deleting the recipient information from the recipient information memory unit where a reply in response to the confirmation request transmitted by the confirmation request transmission unit requests to delete the recipient information.

7. The communication terminal apparatus according to claim 5 further comprising:
a registration requester information memory unit for memorizing registration requester information specifying a second recipient of a second mail;
a registration requester information input unit for inputting the registration requester information;
a registration requester information registration unit for registering to the registration requester information memory unit the registration requester information inputted with the registration requester information input unit;
a deletion notification mail generation unit for generating a deletion notification mail notifying that the recipient information is deleted; and
a deletion notification mail transmission unit for transmitting to the second recipient specified in the registration requester information the deletion notification mail generated by the deletion notification mail generation unit where the recipient information deletion unit deletes the recipient information from the recipient information memory unit.

8. The communication terminal apparatus according to claim 5 further comprising:
a reconfirmation request notification mail generation unit for generating a reconfirmation request mail; and
a reconfirmation request notification mail transmission unit for transmitting to the second recipient specified in the registration requester information the reconfirmation request notification mail generated by the reconfirmation request notification mail generation unit where the reply in response to the confirmation request transmitted by the confirmation request transmission unit is neither requesting to delete the recipient information nor requesting to register the recipient information.
